(19) United States
(12) Patent Application Publication
(10) Pub. No.: US 2024/0104890 A1
(43) Pub. Date: Mar. 28, 2024

(54) IMAGE PROCESSING DEVICE, RECORDING MEDIUM, AND IMAGE PROCESSING METHOD

(71) Applicants: MITSUBISHI ELECTRIC CORPORATION, Tokyo (JP); UMEMURA EDUCATIONAL INSTITUTIONS, Aichi (JP)

(72) Inventors: Osamu NASU, Tokyo (JP); Manabu HASHIMOTO, Aichi (JP)

(73) Assignees: Mitsubishi Electric Corporation, Tokyo (JP); UMEMURA Educational Institutions, Aichi (JP)

(21) Appl. No.: 18/265,972

(22) PCT Filed: Dec. 28, 2020
(86) PCT No.: PCT/JP2020/049147

§ 371 Date: Jun. 8, 2023

(51) Int. Cl. G06V 10/75

(52) U.S. Cl. CPC G06V 10/751

(57) ABSTRACT

An image processing device includes a template analyzer to transform a pattern included in a template into multiple transformed patterns and generate multiple extended templates consisting of the template and multiple transformed templates including the respective transformed patterns. Further, there is a search processor to perform a first search that searches a to-be-searched image by using multiple first extended templates selected from the multiple extended templates, and perform a second search that searches the to-be-searched image by using multiple second extended templates selected from the multiple extended templates on a basis of a result of the first search. The first search is performed by using the template and two or more transformed templates selected at coarse boundaries from the multiple extended templates, and the second search is performed by using two or more extended templates near one of the extended templates that has been detected in the first search.

### TECHNICAL FIELD

The present disclosure relates to an image processing device, a program, and an image processing method.

### BACKGROUND ART

Template matching is widely known as a method for detecting a specific pattern from an image. In template matching, a template representing a pattern to be detected is prepared in advance, and a portion most similar to the pattern represented by the template is detected from an image to be searched, by comparing the pattern with portions of the image to be searched.

In template matching, it is possible to detect a portion having a pattern identical to the pattern represented by the template. However, depending on the composition of the imaging, when the portion is subjected to rotation, scaling, deformation, or the like, the portion is different from the pattern represented by the template in angle, size, shape, or the like, and the portion cannot be detected.

Thus, an object tracking method described in Patent Literature 1 deals with rotation, scaling, or deformation by extending a template to multiple templates by rotating, scaling, or deforming the template, and comparing all the extended multiple templates with portions of an image to be searched.

### CITATION LIST

### Patent Literature

Patent Literature 1: Japanese Patent No. 4843787

### SUMMARY OF INVENTION

### Technical Problem

Although the conventional technique makes it possible to perform a template matching supporting rotation, scaling, or deformation, it requires comparison operations between all the multiple templates and the image to be searched, which requires an extremely large amount of calculation.

Thus, one or more aspects of the present disclosure are intended to make it possible to perform a template matching supporting rotation, scaling, deformation, or the like with a smaller amount of calculation.

### Solution to Problem

An image processing device according to an aspect of the present disclosure includes: a template analyzer to use a plurality of values for transforming a pattern included in a template to different degrees, to transform the pattern into a plurality of transformed patterns, and generate a plurality of extended templates consisting of the template and a plurality of transformed templates including the respective transformed patterns; and a search processor to perform a first search that searches a to-be-searched image by using a plurality of first extended templates selected from the plurality of extended templates, and perform a second search that searches the to-be-searched image by using a plurality of second extended templates selected from the plurality of extended templates on a basis of a result of the first search, wherein the search processor uses, as the plurality of first extended templates, the template and two or more transformed templates corresponding to two or more values selected at first boundaries from a set of the plurality of values arranged in ascending or descending order, the search processor uses, as the plurality of second extended templates, two or more transformed templates corresponding to two or more values that include one or more values corresponding to one or more first extended templates for which the pattern and the plurality of transformed patterns have been detected in the first search and that are selected at second boundaries finer than the first boundaries from a predetermined range, in the set, and a number of values included in the predetermined range is less than a value obtained by subtracting a number of values corresponding to the first extended templates from a number of values included in the set.

A program according to an aspect of the present disclosure causes a computer to function as: a template analyzer to use a plurality of values for transforming a pattern included in a template to different degrees, to transform the pattern into a plurality of transformed patterns, and generate a plurality of extended templates consisting of the template and a plurality of transformed templates including the respective transformed patterns; and a search processor to perform a first search that searches a to-be-searched image by using a plurality of first extended templates selected from the plurality of extended templates, and perform a second search that searches the to-be-searched image by using a plurality of second extended templates selected from the plurality of extended templates on a basis of a result of the first search, wherein the search processor uses, as the plurality of first extended templates, the template and two or more transformed templates corresponding to two or more values selected at first boundaries from a set of the plurality of values arranged in ascending or descending order, the search processor uses, as the plurality of second extended templates, two or more transformed templates corresponding to two or more values that include one or more values corresponding to one or more first extended templates for which the pattern and the plurality of transformed patterns have been detected in the first search and that are selected at second boundaries finer than the first boundaries from a predetermined range, in the set, and a number of values included in the predetermined range is less than a value obtained by subtracting a number of values corresponding to the first extended templates from a number of values included in the set.

An image processing method according to an aspect of the present disclosure includes: using a plurality of values for transforming a pattern included in a template to different degrees, to transform the pattern into a plurality of transformed patterns, and generating a plurality of extended templates consisting of the template and a plurality of transformed templates including the respective transformed patterns; and performing a first search that searches a to-be-searched image by using a plurality of first extended templates selected from the plurality of extended templates, and performing a second search that searches the to-be-searched image by using a plurality of second extended templates selected from the plurality of extended templates on a basis of a result of the first search, wherein the template and two or more transformed templates corresponding to two or more values selected at first boundaries from a set of the plurality of values arranged in ascending or descending order are used as the plurality of first extended templates, two or more transformed templates corresponding to two or more values that include one or more values corresponding to one or more first extended templates for which the pattern and the plurality of transformed patterns have been detected in the first search and that are selected at second boundaries finer than the first boundaries from a predetermined range in the set are used as the plurality of second extended templates, and a number of values included in the predetermined range is less than a value obtained by subtracting a number of values corresponding to the first extended templates from a number of values included in the set.

### Advantageous Effects of Invention

With one or more aspects of the present disclosure, it is possible to perform a template matching supporting rotation, scaling, deformation, or the like with a smaller amount of calculation.

### BRIEF DESCRIPTION OF DRAWINGS

FIG. 1 is a block diagram schematically illustrating configurations of image processing devices according to first and second embodiments.

FIG. 2 is a block diagram schematically illustrating configurations of template analyzers of the first and second embodiments.

FIG. 3 is a block diagram schematically illustrating a configuration of a unique pixel selector of the first embodiment.

FIG. 4 is a block diagram schematically illustrating a configuration of a selected-pixel determiner.

FIG. 5 is a block diagram schematically illustrating a configuration of a search manner determiner,

FIG. 6 is a block diagram schematically illustrating a configuration of a search processor.

FIGS. 7A and 7B are block diagrams illustrating hardware configuration examples.

FIG. 8 is a flowchart illustrating an extension process in a template extender.

FIGS. 9A to 9D are schematic diagrams for explaining the extension process performed by the template extender.

FIG. 10 is a flowchart illustrating a pixel selection process performed by the unique pixel selector in the first embodiment.

FIGS. 11A to 11C are schematic diagrams for explaining selected pixels.

FIGS. 12A to 12D are schematic diagrams for explaining corresponding selected pixels determined in transformed templates generated by rotating a template.

FIG. 13 is a flowchart illustrating a pixel selection process by the selected-pixel determiner.

FIGS. 14A and 14B are schematic diagrams for explaining a process of calculating a co-occurrence histogram.

FIG. 15 is a flowchart illustrating a search process by the search processor.

FIGS. 16A and 16B are schematic diagrams explaining a relationship between a coarse search and a fine search.

FIG. 17 is a block diagram schematically illustrating a configuration of a unique pixel selector of the second embodiment.

FIG. 18 is a flowchart illustrating a pixel selection process performed by a selected-pixel determiner in the second embodiment.

### DESCRIPTION OF EMBODIMENTS

### First Embodiment

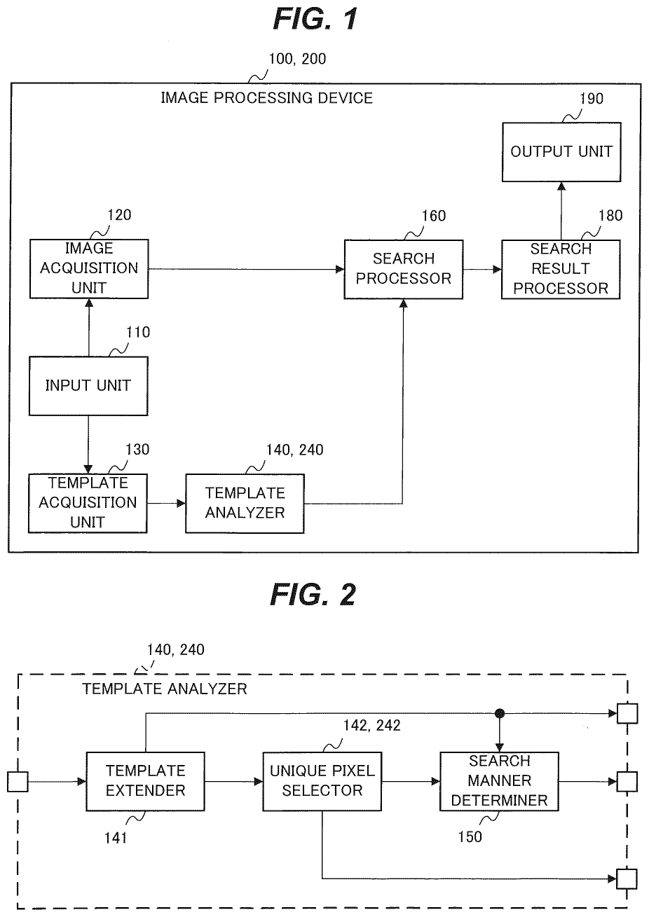

FIG. 1 is a block diagram schematically illustrating a configuration of an image processing device 100 according to a first embodiment.

The image processing device 100 includes an input unit 110, an image acquisition unit 120, a template acquisition unit 130, a template analyzer 140, a search processor 160, a search result processor 180, and an output unit 190.

The image processing device 100 searches an image to be searched (referred to below as a to-be-searched image) represented by to-be-searched image data for a pattern identical to a pattern represented by a template or a pattern similar to the pattern represented by the template, and outputs the search result.

The input unit 110 receives input of to-be-searched image data that is image data of a to-be-searched image that is an image to be subjected to pattern detection, and a template that is image data representing a pattern to be detected.

The image acquisition unit 120 acquires the to-be-searched image data via the input unit 110. The acquired to-be-searched image data is provided to the search processor 160.

The template acquisition unit 130 acquires the template via the input unit 110. The acquired template is provided to the template analyzer 140.

The template analyzer 140 uses multiple values for transforming the pattern included in the template provided from the template acquisition unit 130 to different degrees, to transform the pattern into multiple transformed patterns, and generates multiple transformed templates including the respective transformed patterns. Then, the template analyzer 140 generates multiple extended templates consisting of the template and multiple transformed templates.

For example, the template analyzer 140 generates the multiple transformed templates by using the template provided from the template acquisition unit 130 to rotate, scale, and deform the pattern represented by the template, and provides the template provided from the template acquisition unit 130 and the transformed templates as the multiple extended templates to the search processor 160.

Also, the template analyzer 140 generates information required for the search processor 160 to perform search using the extended templates, and provides the information to the search processor 160.

FIG. 2 is a block diagram schematically illustrating a configuration of the template analyzer 140.

The template analyzer 140 includes a template extender 141, a unique pixel selector 142, and a search manner determiner 150.

The template extender 141 performs duplication and transformation from the single template provided from the template acquisition unit 130 to transformed templates that are templates required for search, and generates multiple extended templates consisting of the single template and the multiple transformed templates. Also, the template extender 141 generates transformation manner information indicating the transformation manners in the transformations from the single template to the multiple transformed templates. Rach transformation manner indicates an extension method (e.g., rotation, scaling, or deformation) and a value (e.g., an angle, a scaling factor, and a deformation rate) in the extension method.

Then, the template extender 141 provides the multiple extended templates and transformation manner information to the unique pixel selector 142, search manner determiner 150, and search processor 160.

For each of the multiple extended templates provided from the template extender 141, the unique pixel selector 142 selects one or more pixels used in search, and generates selected-pixel information indicating the selected pixels.

The selected-pixel information is provided to the search manner determiner 150 and search processor 160.

As the selected-pixel information, information for coarse search and information for fine search that include different information may be separately generated.

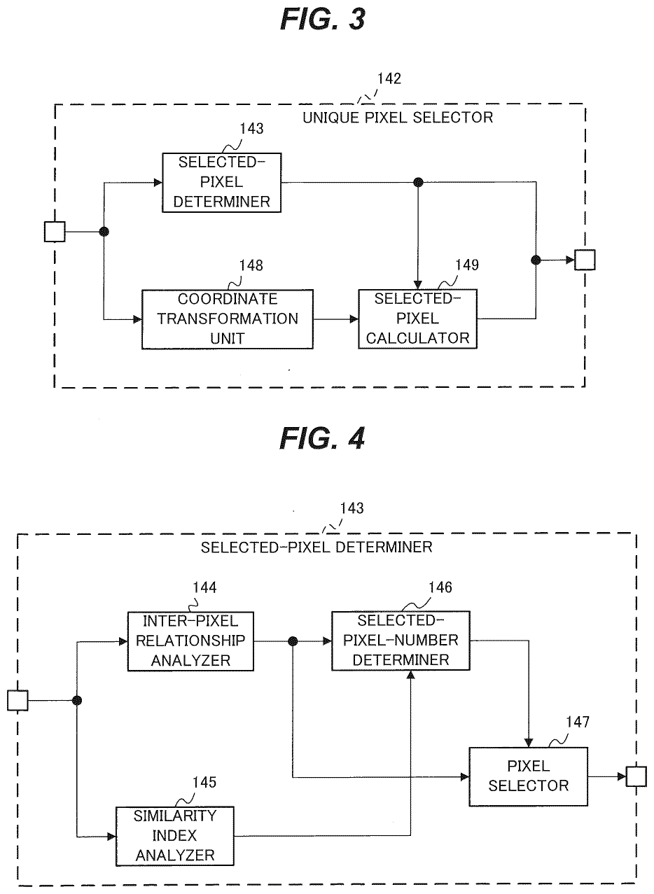

FIG. 3 is a block diagram schematically illustrating a configuration of the unique pixel selector 142.

The unique pixel selector 142 includes a selected-pixel determiner 143, a coordinate transformation unit 143, and a selected-pixel calculator 149.

The selected-pixel determiner 143 determines one or more characteristic pixels in the pattern represented by the template, as the selected pixels, according to a predetermined rule.

FIG. 4 is a block diagram schematically illustrating a configuration of the selected-pixel determiner 143.

The selected-pixel determiner 143 includes an inter-pixel relationship analyzer 144, a similarity index calculator 145, a selected-pixel-number determiner 146, and a pixel selector 147.

The inter-pixel relationship analyzer 144 analyzes relationships between pixel values of multiple pixels having a predetermined positional relationship in the template, and outputs the analysis result. For example, the inter-pixel relationship analyzer 144 generates a histogram of the relationships between the pixel values of the multiple pixels, and provides histogram data representing the generated histogram to the selected-pixel-number determiner 146 and pixel selector 147.

The similarity index calculator 145 calculates similarities between the multiple extended templates provided from the template extender 141, and outputs the calculation result. For example, for each of pairs of two extended templates selected from the multiple extended templates, the similarity index calculator 145 calculates, as the similarity, a sum of absolute differences between the pixels. It is possible to use all the pixels in the templates to calculate a sum of absolute differences between the pixels, or it is possible to divide the templates into certain regions and calculate, for each of the divided regions, a sum of absolute differences between the pixels. Then, the similarity index calculator 145 generates similarity index information indicating the calculated similarity for each of the pairs of selected two extended templates, and provides the generated similarity index information to the selected-pixel-number determiner 146.

The selected-pixel-number determiner 146 determines a selected-pixel number that is the number of pixels selected in searching the to-be-searched image for the pattern represented by the template. For example, the selected-pixel-number determiner 146 may determine the selected-pixel number from a predetermined value, may determine the selected-pixel number from a shape of the histogram generated by the inter-pixel relationship analyzer 144, may determine the selected-pixel number from a distribution of the similarities indicated by the similarity index information generated by the similarity index calculator 145, or may determine the selected-pixel number from a combination of them. The determined selected-pixel number is provided to the pixel selector 142.

Specifically, the selected-pixel-number determiner 146 may determine a predetermined value itself as the selected-pixel number, or may calculate the selected-pixel number by applying a specific formula (e.g., multiplication by a given number) to a predetermined value.

Also, the selected-pixel-number determiner 146 may determine the selected-pixel number so that the selected-pixel number decreases as a variation in frequency between the classes decreases in the histogram generated by the inter-pixel relationship analyzer 144. For the variation in frequency between the classes, it is possible to calculate change rates between adjacent classes and determine the variation in frequency by using a largest value of the change rates or an average value of the change rates. Thus, the selected-pixel-number determiner 146 may decrease the selected-pixel number as the largest value of the change rates decreases, or may decrease the selected-pixel number as the average value of the change rates decreases.

Moreover, the selected-pixel-number determiner 146 may convert the similarities indicated by the similarity index information generated by the similarity index calculator 145 into a histogram, and determine the selected-pixel number so that the selected-pixel number decreases as a variation in frequency between the classes decreases. The above description of the variation in frequency between the classes applies to the variation in frequency between the classes described here.

Also, the selected-pixel-number determiner 146 may determine the selected-pixel number by weighting with predetermined weights and averaging at least two of a value determined from the predetermined value, a value determined from the inter-pixel histogram, and a value determined from the histogram of the similarities between the extended templates, as described above.

The pixel selector 147 determines selected pixels in the template, from the histogram that is a result of the analysis of the relationships between the pixel values provided from the inter-pixel relationship analyzer 144, and the selected-pixel number provided from the selected-pixel-number determiner 146, and generates selected-pixel information indicating the determined pixels. The selected-pixel information is provided to the selected-pixel calculator 149 and search manner determiner 150.

Returning to FIG. 3, the coordinate transformation unit 148 calculates, for each of the multiple transformed templates included in the multiple extended templates, a coordinate transformation formula for performing coordinate transformation between coordinates of a point included in the template and coordinates in the transformed template corresponding to the coordinates of the point, according to the transformation manner indicated by the transformation manner information provided from the template extender 141. Then, for each of the multiple transformed templates, the coordinate transformation unit 148 generates coordinate transformation formula information indicating the calculated coordinate transformation formula and provides the coordinate transformation formula information to the selected-pixel calculator 149.

For each of the multiple transformed templates, by using the coordinate transformation formula indicated by the coordinate transformation formula information provided from the coordinate transformation unit 148 to perform coordinate transformation on coordinates of the selected pixels determined by the selected-pixel determiner 143, the selected-pixel calculator 149 calculates coordinates of corresponding selected pixels that are pixels in the transformed template corresponding to the selected pixels. Then, for each of the multiple transformed templates, the selected-pixel calculator 149 generates corresponding-selected-pixel information indicating the coordinates of the corresponding selected pixels, and provides the corresponding-selected-pixel information to the search manner determiner 150 and search processor 160.

Returning to FIG. 2, the search manner determiner 150 determines search manners in the search processor 160. The search processor 160 performs a coarse search that performs search using extended templates coarsely selected from all the multiple extended templates, and a fine search that finely searches around one or more extended templates further selected from the extended templates used in the coarse search. Thus, the search manner determiner 150 determines a coarse search manner that is a manner of the coarse search and a fine search manner that is a manner of the fine search.

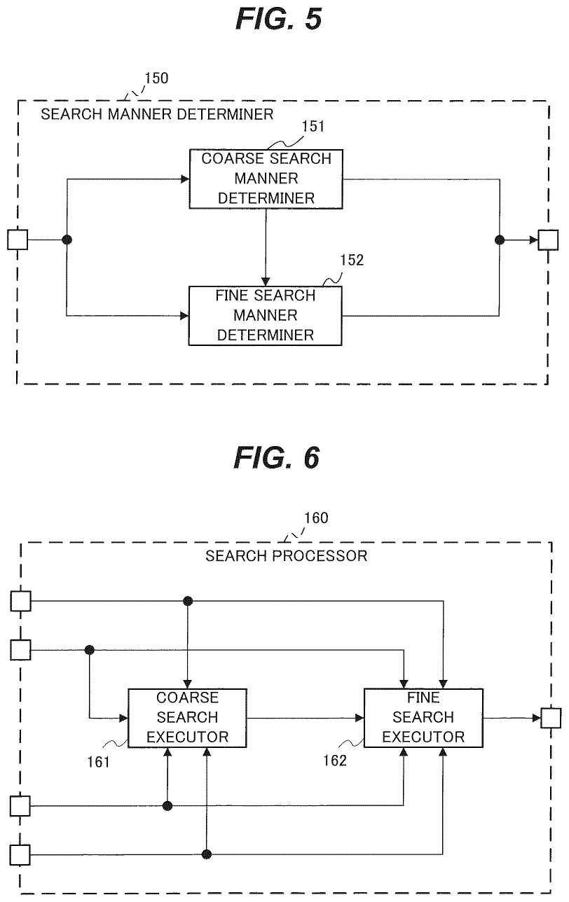

FIG. 5 is a block diagram schematically illustrating a configuration of the search manner determiner 150.

The search manner determiner 150 includes a coarse search manner determiner 151 and a fine search manner determiner 152.

The coarse search manner determiner 151 determines the coarse search manner on the basis of the transformation manner information, selected-pixel information, and the like. For example, when the extension method is rotation, the coarse search manner determiner 151 determines, as the coarse search manner, angular intervals, such as 5° intervals. Also, when the extension method is scaling, the coarse search manner determiner 151 determines, as the coarse search manner, intervals between scaling factors, such as 10% intervals. Moreover, when the extension method is deformation, the coarse search manner determiner 151 determines, as the coarse search manner, intervals between deformation rates, such as 10% intervals. The coarse search manner determiner 151 generates coarse search manner information indicating the coarse search manner determined for each extension method, and provides the coarse search manner information to the fine search manner determiner 152 and search processor 160.

Here, the coarse search manner determiner 151 performs search at coarser intervals than the fine search manner to be described later, over the entire range of the values used in the transformation, by referring to the transformation manner information. Thus, the coarse search manner determiner 151 determines boundaries (or dividing points) of the coarse search manner at intervals coarser than the intervals between the values indicated by the transformation manner information. The intervals of the coarse search manner may be predetermined, or may be determined by a predetermined method (e.g., multiplication) from the intervals between the values of the transformation manners. Moreover, the intervals of the coarse search manner may be determined from a distribution of the similarities indicated by the similarity index information generated by the similarity index calculator 145. For example, the coarse search manner determiner 151 may convert the similarities indicated by the similarity index information generated by the similarity index calculator 145 into a histogram, and determine the intervals between the values of the coarse search manner so that the intervals increase as a variation in frequency between the classes decreases. Moreover, the coarse search manner determiner 151 may determine the intervals of the coarse search manner so that the intervals between the values increase as the selected-pixel number decreases. The intervals between the values need not be regular.

The fine search manner determiner 152 determines the fine search manner on the basis of the coarse search manner information, transformation manner information, selected-pixel information, and the like. For example, when the extension method is rotation, the fine search manner determiner 152 determines, as the fine search manner, angular intervals, such as 1° intervals, and a search range, such as −5° to +5°. Also, when the extension method is scaling, the fine search manner determiner 152 determines, as the fine search manner, intervals between scaling factors, such as 10% intervals, and a search range, such as −20% to +20%. Moreover, when the extension method is deformation, the fine search manner determiner 152 determines, as the fine search manner, intervals between deformation rates, such as 10% intervals, and a search range, such as −20% to +20%. The fine search manner determiner 152 generates fine search manner information indicating the fine search manner determined for each extension method, and provides the fine search manner information to the search processor 160.

Here, the fine search manner determiner 152 may determine the search range of the fine search manner so that the search range can cover the intervals indicated by the coarse search manner, by referring to the coarse search manner information. For example, it is preferable that when search is performed by using the extended template corresponding to a certain value in the coarse search manner, the search range be set to at least cover a range between an average value between the certain value and a value adjacent to the certain value in the coarse search manner and the adjacent value. To achieve the purpose of reducing the amount of calculation, the number of values included in the search range of the fine search manner needs to be less than a value obtained by subtracting the number of the values corresponding to the coarse search from the number of the values included in the set.

Also, the fine search manner determiner 152 may determine the intervals of the fine search manner by referring to the transformation manner information. For example, the fine search manner determiner 152 may determine the intervals of the fine search manner in conformity to the intervals at which the transformed templates are generated from the template. This is not mandatory when similarities between adjacent templates are extremely high. The fine search manner determiner 152 may increase the intervals as the number of selected pixels indicated by the selected-pixel information decreases. As with the coarse search manner, the intervals of the fine search manner also need not be regular.

Moreover, in the fine search manner, on the basis of information that indicates a position where a target pattern is included and that is included in a result of the coarse search, a spatial search range in the to-be-searched image may be determined so that it includes the position where the target pattern is included and is narrower than the entire to-be-searched image.

Returning to FIG. 1, the search processor 160 performs the coarse search, which is a first search that searches the to-be-searched image by using multiple first extended templates that are extended templates selected from the multiple extended templates.

Here, the search processor 160 uses, as the multiple first extended templates, the original template and two or more transformed templates corresponding to two or more values selected at first boundaries from a set of the multiple values arranged in ascending or descending order.

Here, the first boundaries follow the coarse search manner determined by the coarse search manner determiner 151. Thus, the first boundaries may be predetermined, may be coarser as the similarities between the multiple extended templates are higher, or may be coarser as the variation in frequency in the histogram of the relationships between the pixel values of the multiple pixels having the predetermined positional relationship in the template is smaller.

Also, the search processor 160 performs the fine search, which is a second search that searches the to-be-searched image by using multiple second extended templates that are extended templates selected from the multiple extended templates, on the basis of the result of the coarse search.

Here, the search processor 160 uses, as the multiple second extended templates, two or more transformed templates corresponding to two or more values that include one or more values corresponding to one or more first extended templates for which the pattern and transformed patterns have been detected in the coarse search and that are selected at second boundaries finer than the first boundaries from a predetermined range, in the above-described set. The number of values included in the predetermined range is less than a value obtained by subtracting the number of values corresponding to the first extended templates from the number of values included in the above-described set.

Here, the second boundaries follow the fine search manner determined by the fine search manner determiner 152.

Also, in the coarse search, whether one or more of the pattern and multiple transformed patterns are included in the to-be-searched image is detected, and when one or more patterns are included, positions where the one or more target patterns are included, and relationships of the one or more target patterns to the pattern are detected. In the fine search, positions where one or more target patterns that are one or more of the pattern and multiple transformed patterns are included in the to-be-searched image, and relationships of the one or more target patterns to the pattern are detected. Each of the relationships may be at least one of a rotation angle, a scaling factor, and a deformation rate.

Also, the search processor 160 may perform the coarse search or fine search by comparing respective pixel values of one or more pixels selected from a target extended template that is one of the multiple extended templates used in the coarse search or fine search, with pixel values of respective pixels corresponding to the one or more pixels of a partial image cut from the to-be-searched image and having the same size as the target extended template. The one or more pixels follow the selected-pixel information generated by the unique pixel selector 142, and the number of the pixels is less than the total number of pixels included in the target extended template, which can reduce the processing load of the comparison operation.

Here, when the target extended template is one of the multiple transformed templates, coordinates of each of the selected one or more pixels are calculated from coordinates of the one or more pixels selected in the template, by using the coordinate transformation formula for transforming coordinates of pixels included in the pattern to coordinates of pixels of the transformed pattern included in the target extended template.

The number of the selected one or more pixels may decrease as the similarities between the multiple extended templates increase. Also, the number of the selected one or more pixels may decrease as the variation in frequency in the histogram of the relationships between the pixel values of the multiple pixels having the predetermined positional relationship in the template decreases.

FIG. 6 is a block diagram schematically illustrating a configuration of the search processor 160.

The search processor 160 includes a coarse search executor 161 and a fine search executor 162.

The coarse search executor 161 performs the coarse search on the to-be-searched image represented by the to-be-searched image data provided from the image acquisition unit 120, in the coarse search manner indicated by the coarse search manner information provided from the template analyzer 140, using the extended templates provided from the template analyzer 140. Then, the coarse search executor 161 provides the transformation manner for an extended template of the multiple extended templates for which the corresponding pattern has been found in the to-be-searched image, as a coarse search result that is a result of the coarse search, to the fine search executor 162.

On the basis of the coarse search result, the fine search executor 162 performs the fine search on the to-be-searched image represented by the to-be-searched image data provided from the image acquisition unit 120, in the fine search manner indicated by the fine search manner information provided from the template analyzer 140, using the extended templates provided from the template analyzer 140.

For example, the fine search executor 162 determines, from the transformation manner included in the coarse search result, the extension method and value thereof, and determines, from the search range of the fine search manner indicated by the fine search manner information, a search execution range in which the fine search is performed. For example, when the extension method included in the coarse search result is rotation, the value thereof is 12°, and the search range of the fine search manner indicated by the fine search manner information is −5° to +50, the fine search executor 162 determines 7° to 17° as the search execution range. Then, the fine search executor 162 searches the to-be-searched image, using each of the multiple extended templates transformed with values in the search execution range 7° to 17°.

Then, the fine search executor 162 provides a fine search result that is a search result in the fine search, as a final search result, to the search result processor 180. The fine search result includes a position where a corresponding pattern has been found in the to-be-searched image, the value of the extension method for the template of a pattern that has been found in the to-be-searched image, or the like.

The search result processor 180 performs a process of converting the search result provided from the search processor 160 to a predetermined format and outputting it.

The output unit 190 performs output according to an instruction from the search result processor 180. For example, it outputs the search result by means of an image, sound, or the like.

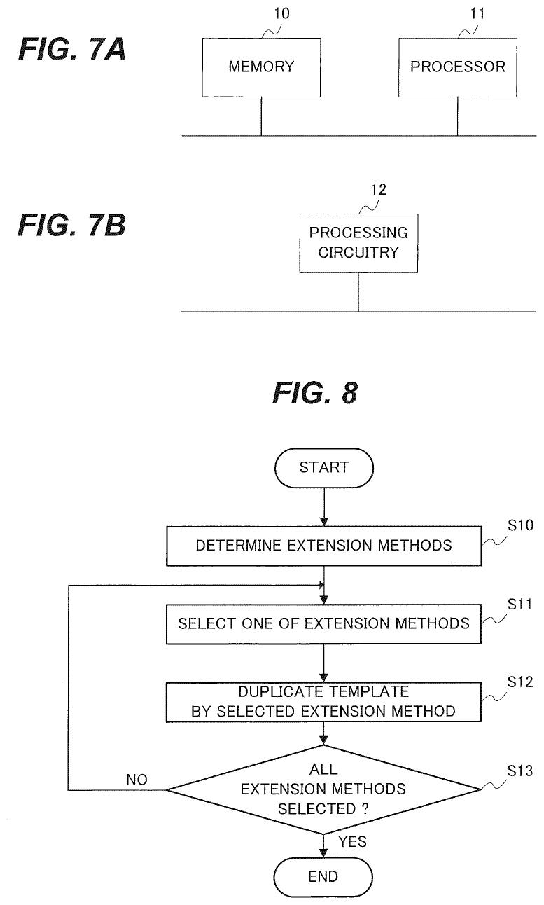

Part or all of the image acquisition unit 120, template acquisition unit 130, template analyzer 140, search processor 160, and search result processor 180 described above can be formed by a memory 10 and a processor 11, such as a central processing unit (CPU), that executes a program stored in the memory 10, as illustrated in FIG. 7A, for example. Such a program may be provided via a network, or may be recorded and provided in a recording medium. Thus, such a program may be provided as a program product, for example. In this case, the image processing device 100 can be implemented by a so-called computer.

Also, part or all of the image acquisition unit 120, template acquisition unit 130, template analyzer 140, search processor 160, and search result processor 180 can be formed by processing circuitry 12, such as a single circuit, a composite circuit, a processor that operates with a program, a parallel processor that operates with a program, an application specific integrated circuit (ASIC), or a field programmable gate array (FPGA), as illustrated in FIG. 7B, for example.

As above, the image acquisition unit 120, template acquisition unit 130, template analyzer 140, search processor 160, and search result processor 180 can be implemented by a processing circuit network.

The input unit 110 can be implemented by an interface, such as a communication interface.

Also, the output unit 190 can be implemented by an output device, such as a display or speaker.

Next, a process by the image processing device 100 according to the first embodiment will be described with reference to drawings.

FIG. 8 is a flowchart illustrating an extension process in the template extender 141.

First, the template extender 141 determines one or more extension methods to be performed (S10). For example, the extension methods to be performed may be predetermined, or may be input via the input unit 110 or an input device (not illustrated), such as a keyboard or mouse, when a search process is performed by the image processing device 100.

Then, the template extender 141 selects one of the determined extension methods (S11).

Then, the template extender 141 generates transformed templates from the template according to the selected extension method (S12). The template and transformed templates constitute multiple extended templates.

Then, the template extender 141 determines whether all the extension methods determined in step 310 have been selected (S13). When all the extension methods have been selected (Yes in S13), the process ends. When there remain extension methods that have not yet been selected (No in S13), the process returns to step S11. In step S11, one of the extension methods that have not yet been selected is selected.

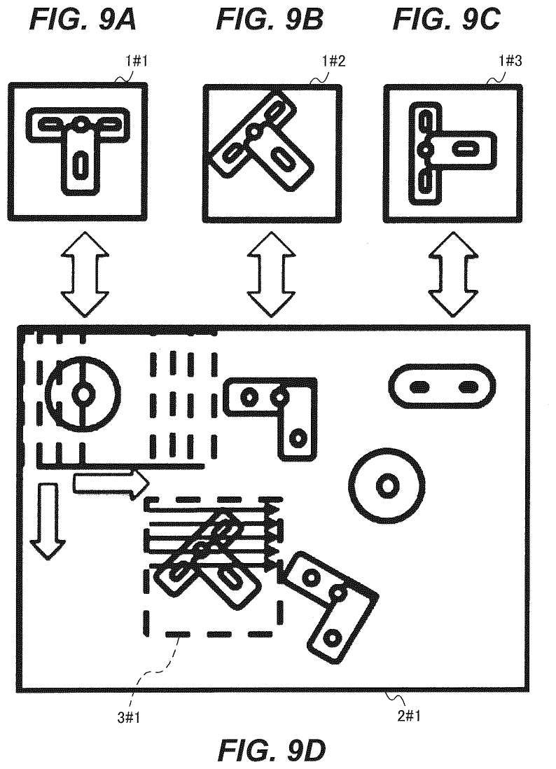

FIGS. 9A to 9D are schematic diagrams for explaining the extension process performed by the template extender 141.

Here, a case where the extension method is rotation will be described as an example.

In a common template matching, no rotated patterns can be found. Thus, it is necessary to previously rotate a template and perform a search process.

Here, it is assumed that template 1 #1 illustrated in FIG. 9A is input.

Even when template 111 is input, it is not possible to find the pattern in portion 3 #1 in to-be-searched image 2 #1 illustrated in FIG. 9D. This is because a position of the same pattern is tried to be detected by comparing template 1 #1 to the image of portion 3 #1 cut from to-be-searched image 2 #1 and having the same size as template 1 #1.

On the other hand, by searching using a template obtained by rotating template 1 #1 as in transformed template 1 #2 illustrated in FIG. 9B, it is possible to find the pattern included in portion 3 #1.

It is unknown how many degrees a pattern corresponding to the pattern represented by template 1 #1 is rotated in to-be-searched image 2 #1. Thus, the template extender 141 previously generates transformed templates, such as transformed template 1 #2 illustrated in FIG. 9B and transformed template 143 illustrated in FIG. 9C, rotated by different angles.

At this time, when the extension method is provided with the information that rotation intervals are 1°, for rotations corresponding to 360°, besides the original template 1 #1, 359 transformed templates are generated at respective rotation angles. Then, the template extender 141 combines the 359 transformed templates and original template 1 #1 and provides the 360 extended templates to the unique pixel selector 142, search manner determiner 150, and search processor 160.

Although the above description takes rotation as an example, the extension process is similarly performed also in extension methods such as scaling or deformation. Also, different extension methods, such as rotation and scaling, may be combined.

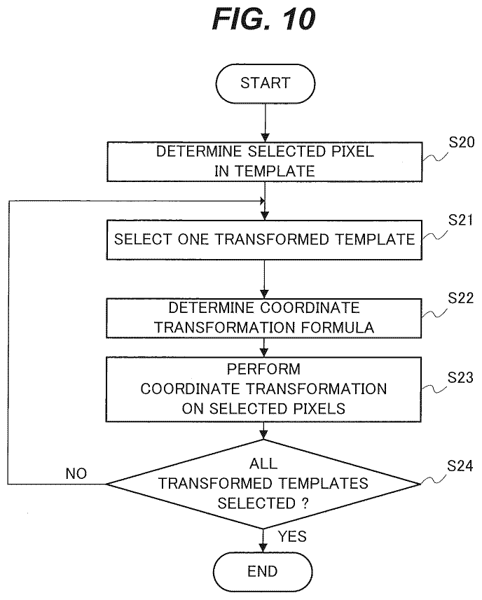

FIG. 10 is a flowchart illustrating a pixel selection process performed by the unique pixel selector 142.

First, the selected-pixel determiner 143 included in the unique pixel selector 142 determines selected pixels in the original template (S20).

Then, the coordinate transformation unit 148 selects one of the multiple transformed templates (S21).

Then, the coordinate transformation unit 148 determines a coordinate transformation formula between coordinates included in the original template and coordinates included in the selected transformed template, from the transformation manner of the selected transformed template (S22).

Then, the selected-pixel calculator 149 calculates coordinates of the corresponding selected pixels by performing coordinate transformation on the selected pixels determined from the original template by means of the coordinate transformation formula determined by the selected-pixel calculator 149 (S23). Then, for each of the multiple transformed templates, the selected-pixel calculator 149 generates corresponding-selected-pixel information indicating the calculated corresponding selected pixels, and provides the corresponding-selected-pixel information to the search manner determiner 150 and search processor 160.

Then, the coordinate transformation unit 148 determines whether all the transformed templates have been selected (S24). When all the transformed templates have been selected (Yes in S24), the process ends. When there remain transformed templates that have not yet been selected (No in S24), the process returns to step 821. In step S21, one of the transformed templates that have not yet been selected is selected,

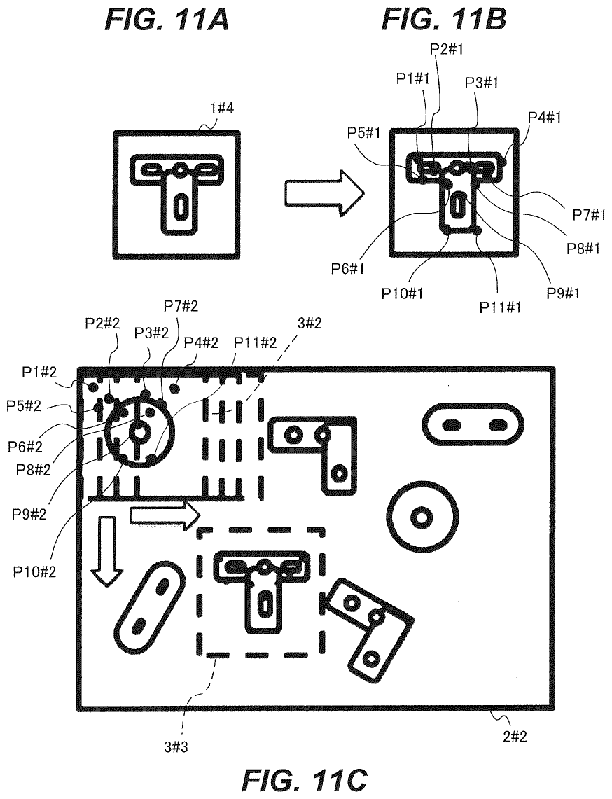

FIGS. 11A to 11C are schematic diagrams for explaining the selected pixels.

Here, the selected pixels determined from the template will be described.

The selected-pixel determiner 143 determines, from template 1 #4 illustrated in FIG. 11A, selected pixels P1 #1 to P11 #1 illustrated in FIG. 11B, for example.

Then, as illustrated in FIG. 11C, the search processor 160 cuts portion 3 #2 having the same size as template 1 #4 out of to-be-searched image 2 #2. Then, the search processor 160 can detect a pattern match by comparing pixel values of selected pixels P1 #1 to P11 #1 with pixel values of pixels P1 #2 to P11 #2 located at the same coordinates as selected pixels P1 #1 to P11 #1, in portion 3 #2.

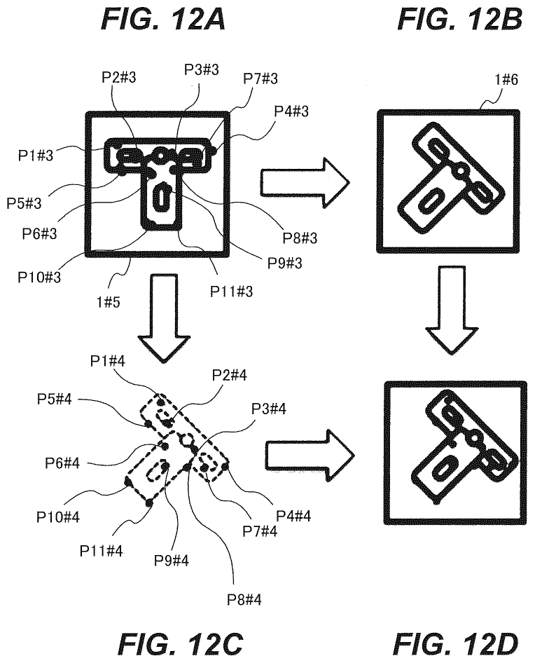

FIGS. 12A to 12D are schematic diagrams for explaining the corresponding selected pixels determined in the transformed templates generated by rotating the template.

FIG. 12A illustrates template 1 #5 and selected pixels P1 #1 to P11 #3 determined from template 1 #5.

FIG. 12B illustrates transformed template 106 generated by rotating template 1 #5 by 45° clockwise.

FIG. 12C illustrates corresponding selected pixels P1 #4 to P11 #4 calculated according to the transformation manner of transformed template 1 #6.

FIG. 12D is a diagram obtained by superimposing corresponding selected pixels P1 #4 to P11 #4 on transformed template 1 #6.

As illustrated in FIG. 12C, corresponding selected pixels P1 #4 to P11 #4 can also be calculated by rotating selected pixels P1 #1 to P11 #3 by 45° clockwise similarly to transformed template 1 #6.

Here, when the extension method is rotation, and a transformed template is generated by rotating the template by an angle θ counterclockwise, the coordinate transformation formula calculated by the coordinate transformation unit 148 is expressed by the following equation (1):

$$[ \begin{matrix}{x}^{′} \\ {y}^{′}\end{matrix} ] = [ \begin{matrix}cos θ & - sin θ \\ sin θ & cos θ\end{matrix} ] [ \begin{matrix}x - w / 2 \\ y - h / 2\end{matrix} ] + [ \begin{matrix}w / 2 \\ h / 2\end{matrix} ] . \qquad ( 1 )$$

In equation (1), (x, y) axe coordinates before the coordinate transformation, and are coordinates in the template; (x′, y′) are coordinates after the coordinate transformation, and are coordinates in the transformed template; w is a width of the template; and h is a height of the template.

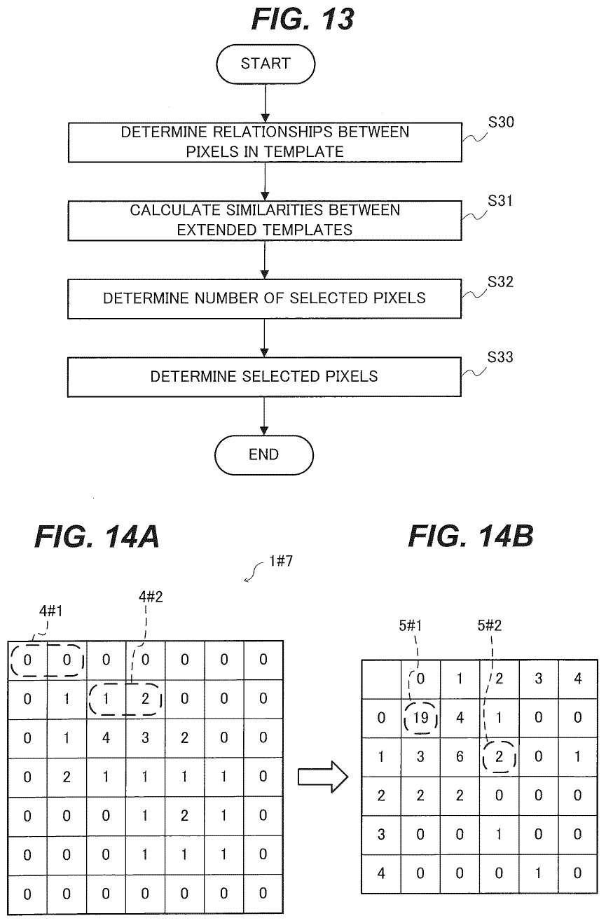

FIG. 13 is a flowchart illustrating a pixel selection process by the selected-pixel determiner 143.

First, the inter-pixel relationship analyzer 144 determines relationships between pixels in the template (S30). The relationships between the pixels serve as indices for calculating a uniqueness of each pixel in the template. The uniqueness indicates that the pixel is a characteristic pixel significantly representing the pattern of the template. Depending on the definition of the uniqueness, for example, pixels at boundaries or corners of the pattern are high in uniqueness.

The relationships between the pixels can be determined on the basis of co-occurrence probabilities, for example. The co-occurrence probabilities are obtained by dividing the frequencies of a co-occurrence histogram by the number of pixels. The co-occurrence histogram is a histogram obtained by determining an occurrence frequency of a pair of pixel values p and q of a pixel pair consisting of two pixels having a predetermined positional relationship in the image, over the entire image, and arranging the occurrence frequencies in a two-dimensional matrix with the pixel values p and q as vertical and horizontal indices, respectively.

The frequency h₂(p,q) at indices (p,q) of the co-occurrence histogram can be determined by the following equations (2) and (3):

$${h}_{2} ( p , q ) = {\sum }_{{v}_{P} , {v}_{Q} ∈ {R}_{2}} {δ}_{2} ( {v}_{P} , {v}_{Q} , p , q ) , \qquad ( 2 )$$

$${δ}_{2} ( {v}_{P} , {v}_{Q} , p , q ) = \{ \begin{matrix}1 & when \{ f ( {v}_{P} ) = p \} ⋂ \{ f ( {v}_{Q} ) = q \} \\ 0 & otherwise\end{matrix} , \\ where {v}_{P} = {v}_{Q} + d \qquad ( 3 )$$

where vₚ is a position vector of a pixel P, v_{q} is a position vector of a pixel Q, f(v) is a pixel value of a pixel located at a position vector v, and d is a predetermined difference vector between the position vectors. Thus, according to the vector d, which is a predetermined fixed vector, the positional relationship between the pixels P and Q is also constant.

In the case of an 8-bit depth image as a typical image, since each pixel value ranges from 0 to 255, p and q also range from 0 to 255, and the co-occurrence histogram is represented by a square matrix with 256 rows and 256 columns.

In addition, since vₚ and v_{g} are the position vectors of the pixels P and Q, the components of each position vector range from 0 to the values of vertical and horizontal sizes of the template.

FIGS. 14A and 14B are schematic diagrams for explaining a process of calculating the co-occurrence histogram.

Here, for simplification of explanation, it is assumed that each pixel value has 5 grayscale levels from 0 to 4, template 1 #7 has 49 pixels in 7 rows and 7 columns as illustrated in FIG. 14A, and the difference vector d is (1,0). Thus, the pixel pair (P,Q) is two horizontally adjacent pixels.

FIG. 14B is a table showing the frequencies of the co-occurrence histogram.

For example, according to FIG. 14B, as shown in cell 5 #1, the number of pixel pairs of horizontally adjacent pixels having pixel values of (0,0), such as pixel pair 4 #1 of FIG. 14A, in template 1 #7 is 19.

Similarly, as shown in cell 5 #2, the number of pixel pairs having pixel values of (1,2), such as pixel pair 4 #2, is 2.

Although the pixel pairs consisting of two pixels have been taken as an example, the same holds when pixel groups consisting of three or more pixels having a predetermined positional relationship are used. For example, when pixel groups consisting of three pixels having a predetermined positional relationship are used, the co-occurrence histogram is represented by a three-dimensional matrix. In this embodiment, the number of pixels constituting the pixel group is not limited, and any co-occurrence histograms can be used.

The inter-pixel relationship analyzer 144 may generate different co-occurrence histograms on the basis of different predetermined positional relationships, and generate a new histogram by using a weighted average of them. In this case, the selected-pixel-number determiner 146 and pixel selector 147 may use the new histogram.

Returning to FIG. 13, the similarity index calculator 145 then calculates similarities between the multiple extended templates (S31). For example, when the extension method is rotation, in the case of a minute rotation angle or in a flat region having uniform pixel values, the changes in the pixel values due to the rotation are small, and the similarity between the two templates is high.

Then, the selected-pixel-number determiner 146 determines the selected-pixel number by using the histogram generated by the inter-pixel relationship analyzer 144 and the similarities calculated by the similarity index calculator 145 (S32). Here, the selected-pixel-number determiner 146 determines the selected-pixel number by weighting with predetermined weights and averaging a value determined from the histogram and a value determined from the similarities. The selected-pixel-number determiner 146 may determine the selected-pixel number by other methods.

Then, the pixel selector 147 determines the selected pixels in the template, from the histogram, which is a result of the analysis of the relationships between the pixel values, provided from the inter-pixel relationship analyzer 144, and the selected-pixel number provided from the selected-pixel-number determiner 146 (S33). For example, the pixel selector 147 may select the pixels in ascending order of co-occurrence probability excluding 0. This is because when a co-occurrence probability is low, the probability that the pair of pixel values exists in the template is low. That is, this is because a pixel pair having a low co-occurrence probability is a characteristic pixel pair.

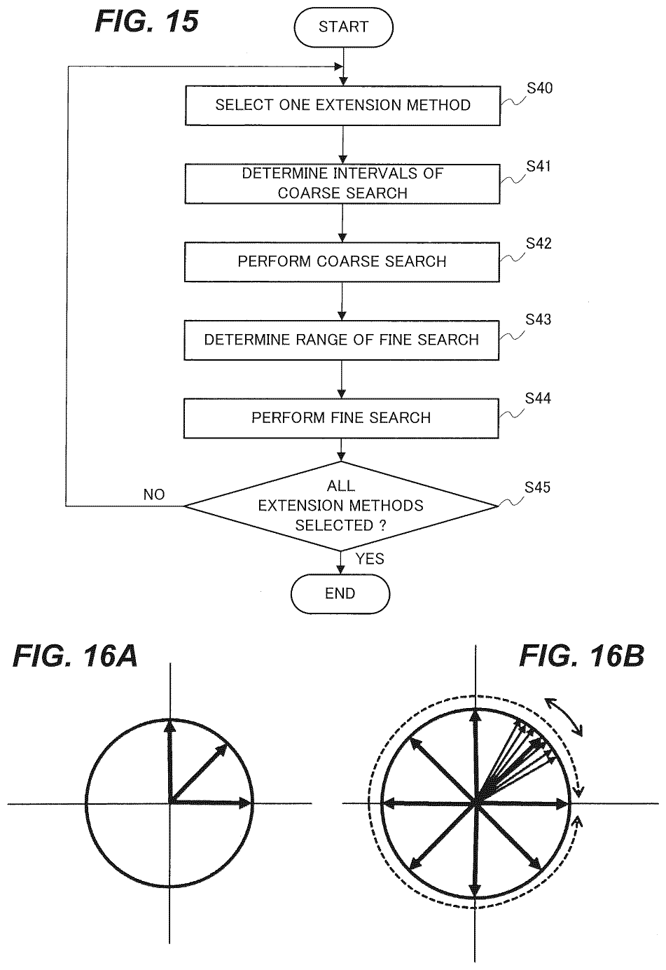

FIG. 15 is a flowchart illustrating a search process by the search processor 160.

First, the coarse search executor 161 selects one of the extension methods by referring to the coarse search manner information provided from the search manner determiner 150 (S40).

Then, the coarse search executor 161 determines intervals of the coarse search in the extension method selected in step S40, according to the coarse search manner indicated by the coarse search manner information provided from the search manner determiner 150 (S41).

Then, the coarse search executor 161 performs the coarse search in the extension method selected in step S40, at the intervals determined in step S41 (S42). When the pattern included in an extended template has been detected in the to-be-searched image, the coarse search executor 161 provides the value (e.g., the angle, scaling factor, or deformation rate) corresponding to the extended template, as a result of the coarse search, to the fine search executor 162.

Then, the fine search executor 162 determines the search execution range of the fine search, on the basis of the result of the coarse search from the coarse search executor 161, according to the fine search manner indicated by the fine search manner information provided from the search manner determiner 150 (943). When none of the patterns included in the extended templates are detected in the to-be-searched image by the coarse search executor 161, the fine search executor 162 may determine the entire range in the extension method as the search execution range. The entire range in the extension method may be determined from the coarse search manner information.

Then, the fine search executor 162 performs the fine search in the execution search range determined in step S43 by using the corresponding extended templates (S44).

Then, the coarse search executor 161 determines whether all the extension methods have been selected (S45). When all the extension methods have been selected (Yes in S45), the process ends. On the other hand, when there remain extension methods that have not yet been selected (No in S45), the process returns to step S40, and the coarse search executor 161 selects one of the extension methods that have not yet been selected.

FIGS. 16A and 16B are schematic diagrams explaining a relationship between the coarse search and fine search.

Here, description will be made by taking, as an example, a case where the extension method is rotation.

To perform a template matching that deals with rotation, it is necessary to use rotated multiple templates to perform a template matching for each angle. For example, when a matching is performed at intervals of 1°, 360 template matchings are performed.

In the coarse search and fine search, a search is first performed at coarse angles by the coarse search, and a detail search is then performed by the fine search. In the example illustrated in FIG. 16, the coarse search is performed at intervals of 45° as illustrated in FIG. 16A. When the coarse search has found that the pattern included in the extended template at a position of 45° substantially matches a pattern included in the to-be-searched image, the fine search is performed at intervals of 1° with a range around 450 as the search execution range as illustrated in FIG. 16B. Here, when it is assumed that the search execution range is a 50° range centered at 45°, 50 fine searches are performed in the range of 20° to 0°. In this case, since the number of coarse searches is 8, a total of 58 template matchings are performed. Compared to 360 template matchings with 360° as the search execution range, the number of times can be greatly reduced.

Also, in performing search, a comparison is made between each of the extended templates and a partial image that is a portion cut from the to-be-searched image and having the same size as the template. For example, a sum of absolute differences between pixel values at the same positions is obtained. However, in this embodiment, comparison operation is performed for only the pixels selected by the unique pixel selector 142 and output by the template analyzer 140. This can greatly reduce the amount of calculation, compared to comparing all the pixels.

### Second Embodiment

As illustrated in FIG. 1, an image processing device 200 according to a second embodiment includes an input unit 110, an image acquisition unit 120, a template acquisition unit 130, a template analyzer 240, a search processor 160, a search result processor 180, and an output unit 190.

The input unit 110, image acquisition unit 120, template acquisition unit 130, search processor 160, search result processor 180, and output unit 190 of the image processing device 200 according to the second embodiment are the same as the input unit 110, image acquisition unit 120, template acquisition unit 130, search processor 160, search result processor 180, and output unit 190 of the image processing device 100 according to the first embodiment.

As illustrated in FIG. 2, the template analyzer 240 of the second embodiment includes a template extender 141, a unique pixel selector 242, and a search manner determiner 150.

The template extender 141 and search manner determiner 150 of the template analyzer 240 of the second embodiment are the same as the template extender 141 and search manner determiner 150 of the template analyzer 140 of the first embodiment.

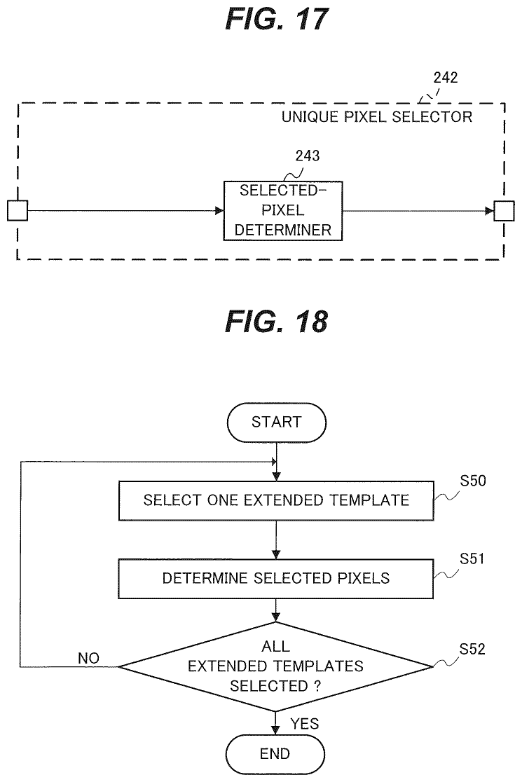

FIG. 17 is a block diagram schematically illustrating a configuration of the unique pixel selector 242 of the second embodiment.

The unique pixel selector 242 includes a selected-pixel determiner 243. The unique pixel selector 242 of the second embodiment does not include the coordinate transformation unit 148 and selected-pixel calculator 149 of the unique pixel selector 142 of the first embodiment.

The selected-pixel determiner 243 determines, for each of the multiple extended templates, one or more characteristic pixels in the pattern represented by the extended template, as selected pixels, according to a predetermined rule.

Specifically, when the target extended template is the template, the one or more selected pixels are selected from the template. On the other hand, when the target extended template is one of the multiple transformed templates, the one or more selected pixels are selected from the target extended template.

FIG. 18 is a flowchart illustrating a pixel selection process performed by the selected-pixel determiner 243.

First, the selected-pixel determiner 243 selects one of the multiple extended templates (S50).

Then, the selected-pixel determiner 243 determines one or more selected pixels from the selected extended template (551).

Then, the selected-pixel determiner 243 determines whether all the extended templates have been selected (S52). When all the extended templates have been selected (Yes in S52), the process ends. When there remain extended templates that have not yet been selected (No in S52), the process returns to step S50, and the selected-pixel determiner 243 selects one of the extended templates that have not yet been selected.

While the selected-pixel determiner 143 of the first embodiment performs pixel selection on the original, template, the selected-pixel determiner 243 of the second embodiment performs pixel selection on each of the multiple extended templates. The method for pixel selection in the second embodiment is the same as that in the first embodiment.

In the above first and second embodiments, the pixel selector 147 determines the selected pixels in the template from the histogram that is a result of the analysis of the relationships between the pixel values provided from the inter-pixel relationship analyzer 144, and the selected-pixel number provided from the selected-pixel-number determiner 146. Specifically, the selected pixels are selected in the template in order from a pixel having a lowest of the co-occurrence probabilities calculated from the histogram. However, the first and second embodiments are not limited to such an example.

For example, the similarity index calculator 145 calculates, for each pixel, a pixel similarity that is a similarity of the pixel, by calculating, for each of all pairs of two extended templates selected from the multiple extended templates, absolute differences of the respective pixels in the pair, and summing, for each pixel, the calculated absolute differences. Then, the similarity index calculator 145 provides pixel similarity information indicating the calculated pixel similarities to the pixel selector 147.

Then, the pixel selector 147 may determine the selected pixels in the template in order from a pixel having a lowest of the pixel similarities so that pixels having higher pixel similarities are less likely to be selected.

It is possible that, for each of predetermined regions, a value calculated by summing absolute differences of pixels included in the predetermined region is determined as a pixel similarity of the pixels included in the predetermined region.

### REFERENCE SIGNS LIST

100, 200 image processing device, 110 input unit, 120 image acquisition unit, 130 template acquisition unit, 140 template analyzer, 141 template extender, 141, 242, unique pixel selector, 143, 243 selected-pixel determiner, 144 inter-pixel relationship analyzer, 145 similarity index calculator, 146 selected-pixel-number determiner, 147 pixel selector, 148 coordinate transformation unit, 149 selected-pixel calculator, 150 search manner determiner, 151 coarse search manner determiner, 152 fine search manner determiner, 160 search processor, 161 coarse search executor, 162 fine search executor, 180 search result processor, 190 output unit.

1. An image processing device comprising:
a template analyzer to use a plurality of values for transforming a pattern included in a template to different degrees, to transform the pattern into a plurality of transformed patterns, and generate a plurality of extended templates consisting of the template and a plurality of transformed templates including the respective transformed patterns; and
a search processor to perform a first search that searches a to-be-searched image by using a plurality of first extended templates selected from the plurality of extended templates, and perform a second search that searches the to-be-searched image by using a plurality of second extended templates selected from the plurality of extended templates on a basis of a result of the first search,
wherein the search processor uses, as the plurality of first extended templates, the template and two or more transformed templates corresponding to two or more values selected at first boundaries from a set of the plurality of values arranged in ascending or descending order,
the search processor uses, as the plurality of second extended templates, two or more transformed templates corresponding to two or more values that include one or more values corresponding to one or more first extended templates for which the pattern and the plurality of transformed patterns have been detected in the first search and that are selected at second boundaries finer than the first boundaries from a predetermined range, in the set, and
a number of values included in the predetermined range is less than a value obtained by subtracting a number of values corresponding to the first extended templates from a number of values included in the set.

2. The image processing device of claim 1, wherein the first boundaries are predetermined.

3. The image processing device of claim 1, wherein the first boundaries are coarser as a similarity between the plurality of extended templates is higher.

4. The image processing device of claim 1, wherein the predetermined range for determining the second extended templates is predetermined.

5. The image processing device of claim 1, wherein the template analyzer analyzes the plurality of extended templates and determines the predetermined range for determining the second extended templates for each of the one or more values corresponding to one or more first extended templates for which the pattern and the plurality of transformed patterns have been detected in the first search.

6. The image processing device of claim 1, wherein the first boundaries are coarser as a variation in frequency in a histogram of relationships between pixel values of a plurality of pixels having a predetermined positional relationship in the template is smaller.

7. The image processing device of claim 1, wherein the second boundaries are predetermined.

8. The image processing device of claim 1, wherein
in the first search, whether the to-be-searched image includes one of the pattern and the plurality of transformed patterns is detected, and
in the second search, a position where a target pattern that is one of the pattern and the plurality of transformed patterns is included in the to-be-searched image, and a relationship of the target pattern to the pattern are detected.

9. The image processing device of claim 8, wherein the relationship is at least one of a rotation angle, a scaling factor, and a deformation rate.

10. The image processing device of claim 1, wherein
the search processor performs the first search or the second search by comparing respective pixel values of one or more pixels selected from a target extended template that is one of the plurality of extended templates used in the first search or the second search, with pixel values of pixels corresponding to the one or more pixels of a partial image cut from the to-be-searched image and having the same size as the target extended template, and
a number of the one or more pixels is less than a total number of pixels included in the target extended template in each of the first search and the second search.

11. The image processing device of claim 10, wherein the template analyzer analyzes the plurality of extended templates and determines the number of the one or more pixels.

12. The image processing device of claim 10, wherein when the target extended template is one of the plurality of transformed templates, coordinates of each of the one or more pixels are calculated from coordinates of one or more pixels selected in the template, by using a coordinate transformation formula for transforming coordinates of pixels included in the pattern to coordinates of pixels of the transformed pattern included in the target extended template.

13. The image processing device of claim 10, wherein
when the target extended template is the template, the one or more pixels are selected from the template, and
when the target extended template is one of the plurality of transformed templates, the one or more pixels are selected from the target extended template.

14. The image processing device of claim 10, wherein the number of the one or more pixels decreases as a similarity between the plurality of extended templates increases.

15. The image processing device of claim 10, wherein the number of the one or more pixels decreases as a variation in frequency in a histogram of relationships between pixel values of a plurality of pixels having a predetermined positional relationship in the template decreases.

16. The image processing device of claim 15, wherein the one or more pixels are selected in order from a pixel having a lowest of co-occurrence probabilities calculated from the histogram.

17. The image processing device of claim 15, wherein the one or more pixels are selected in order from a pixel having a lowest of pixel similarities calculated by calculating, for each of all pairs of two extended templates selected from the plurality of extended templates, an absolute difference of each pixel in the pair, and summing, for each pixel, the calculated absolute differences.

18. A non-transitory computer-readable recording medium storing a program for causing a computer to function as:
a template analyzer to use a plurality of values for transforming a pattern included in a template to different degrees, to transform the pattern into a plurality of transformed patterns, and generate a plurality of extended templates consisting of the template and a plurality of transformed templates including the respective transformed patterns; and
a search processor to perform a first search that searches a to-be-searched image by using a plurality of first extended templates selected from the plurality of extended templates, and perform a second search that searches the to-be-searched image by using a plurality of second extended templates selected from the plurality of extended templates on a basis of a result of the first search,
wherein the search processor uses, as the plurality of first extended templates, the template and two or more transformed templates corresponding to two or more values selected at first boundaries from a set of the plurality of values arranged in ascending or descending order,
the search processor uses, as the plurality of second extended templates, two or more transformed templates corresponding to two or more values that include one or more values corresponding to one or more first extended templates for which the pattern and the plurality of transformed patterns have been detected in the first search and that are selected at second boundaries finer than the first boundaries from a predetermined range, in the set, and
a number of values included in the predetermined range is less than a value obtained by subtracting a number of values corresponding to the first extended templates from a number of values included in the set.

19. An image processing method comprising:
using a plurality of values for transforming a pattern included in a template to different degrees, to transform the pattern into a plurality of transformed patterns, and generating a plurality of extended templates consisting of the template and a plurality of transformed templates including the respective transformed patterns; and
performing a first search that searches a to-be-searched image by using a plurality of first extended templates selected from the plurality of extended templates, and performing a second search that searches the to-be-searched image by using a plurality of second extended templates selected from the plurality of extended templates on a basis of a result of the first search,
wherein the template and two or more transformed templates corresponding to two or more values selected at first boundaries from a set of the plurality of values arranged in ascending or descending order are used as the plurality of first extended templates,
two or more transformed templates corresponding to two or more values that include one or more values corresponding to one or more first extended templates for which the pattern and the plurality of transformed patterns have been detected in the first search and that are selected at second boundaries finer than the first boundaries from a predetermined range in the set are used as the plurality of second extended templates, and
a number of values included in the predetermined range is less than a value obtained by subtracting a number of values corresponding to the first extended templates from a number of values included in the set.
